(19) United States
(12) Patent Application Publication
(10) Pub. No.: US 2025/0392828 A1
(43) Pub. Date: Dec. 25, 2025

(54) IMAGING APPARATUS AND IMAGING METHOD

(71) Applicant: FUJIFILM Corporation, Tokyo (JP)

(72) Inventor: Masahiko SUGIMOTO, Saitama (JP)

(73) Assignee: FUJIFILM Corporation, Tokyo (JP)

(21) Appl. No.: 19/305,772

(22) Filed: Aug. 21, 2025

Related U.S. Application Data
(63) Continuation of application No. PCT/JP2024/003472, filed on Feb. 2, 2024.

(30) Foreign Application Priority Data
Feb. 27, 2023 (JP) 2023-028795

(51) Int. Cl. H04N 23/80; H04N 23/45; H04N 23/67

(52) U.S. Cl. CPC H04N 23/80; H04N 23/45; H04N 23/67

(57) ABSTRACT

Provided are an imaging apparatus and an imaging method that capture an image in which a target of interest of a subject is detectable. An imaging apparatus includes a camera (10), a distance measurer (20) that measures a distance to wall surfaces (T1, T2) of a tunnel (2), and a processor. The processor is configured to cause the camera (10) to execute first imaging in which split imaging is spatially performed on the tunnel (2) to acquire a captured image, determine whether or not a target of interest is detectable from the captured image based on a distance measurement signal of the distance measurer (20), and cause the camera (10) to execute second imaging, which has an imaging condition different from that of the first imaging, for an imaging range of the tunnel (2) for which the determination is determined to be negative.

### CROSS-REFERENCE TO RELATED APPLICATIONS

The present application is a Continuation of PCT International Application No. PCT/JP2024/003472 filed on Feb. 2, 2024 claiming priority under 35 U.S.C § 119 (a) to Japanese Patent Application No. 2023-028795 filed on Feb. 27, 2023. Each of the above applications is hereby expressly incorporated by reference, in its entirety, into the present application.

### BACKGROUND OF THE INVENTION

### 1. Field of the Invention

The present invention relates to an imaging apparatus and an imaging method, and particularly relates to a technique of capturing an image having a spatial resolution suitable for inspection of a subject.

### 2. Description of the Related Art

In order to inspect various structures such as a bridge, a road, a tunnel, a dam, and a building, a structure is imaged using an imaging apparatus, and the structure is inspected using a captured image obtained by the imaging.

In the related art, an imaging support apparatus that supports imaging such that appropriate imaging is possible in a case where a structure is imaged by this type of imaging apparatus has been proposed (WO2017/126368A).

The imaging support apparatus described in WO2017/126368A acquires required pixel density information of a surface to be imaged of the structure, which is required for recognizing a damage state of the structure. Further, the imaging support apparatus acquires imaging performance information of the imaging apparatus, distance information from the imaging apparatus to the surface to be imaged of the structure, and inclination angle information of the surface to be imaged of the structure with respect to a direction orthogonal to an imaging direction of the imaging apparatus, and calculates an actual pixel density of the surface to be imaged of the structure based on these pieces of information.

The imaging support apparatus determines whether or not the calculated actual pixel density conforms to the required pixel density information, and outputs a determination result.

As the determination result in a case where the actual pixel density is determined not to conform to the required pixel density information, the imaging support apparatus outputs information for urging the imaging apparatus to move (an instruction to bring the imaging apparatus close to the structure) or outputs a command for controlling an imaging position and the imaging direction of the imaging apparatus.

### SUMMARY OF THE INVENTION

One embodiment according to the technique of the present disclosure provides an imaging apparatus and an imaging method that capture an image in which a target of interest of a subject is detectable.

According to a first aspect of the present invention, there is provided an imaging apparatus including a camera, a distance measurer that measures a distance to a subject, and a processor, in which the processor is configured to cause the camera to execute first imaging in which split imaging is spatially performed on the subject to acquire a captured image, determine whether or not a target of interest is detectable from the captured image based on a distance measurement signal of the distance measurer, and cause the camera to execute second imaging, which has an imaging condition different from that of the first imaging, for an imaging range of the subject for which the determination is determined to be negative.

According to a second aspect of the present invention, in the imaging apparatus according to the first aspect, it is preferable that the determination is whether or not a resolution of the captured image falls within an allowable range.

According to a third aspect of the present invention, in the imaging apparatus according to the second aspect, it is preferable that the resolution of the captured image is a spatial resolution of the captured image.

According to a fourth aspect of the present invention, in the imaging apparatus according to any one of the first to third aspects, it is preferable that the subject and the camera are relatively moved in a first direction, and the subject is continuously imaged.

According to a fifth aspect of the present invention, in the imaging apparatus according to the fourth aspect, it is preferable that the spatial resolution of the captured image is a spatial resolution of an entire region of the captured image.

According to a sixth aspect of the present invention, in the imaging apparatus according to the second aspect, it is preferable that the imaging range is an imaging range of the subject that is determined not to fall within the allowable range.

According to a seventh aspect of the present invention, in the imaging apparatus according to the fourth aspect, it is preferable that the first imaging is imaging in which a spatial resolution of a first region in the captured image falls within an allowable range and a spatial resolution of a second region in the captured image does not fall within the allowable range, and the second imaging is imaging in which the spatial resolution of the first region does not fall within the allowable range and the spatial resolution of the second region falls within the allowable range.

According to an eighth aspect of the present invention, in the imaging apparatus according to the third aspect, it is preferable that the processor is configured to estimate the spatial resolution of the captured image based on an imaging setting value of the camera and the distance measurement signal of the distance measurer, and determine whether or not the estimated spatial resolution of the captured image falls within the allowable range.

According to a ninth aspect of the present invention, in the imaging apparatus according to the third aspect or the eighth aspect, it is preferable that the processor is configured to acquire a shortest distance or a longest distance to the subject in the captured image based on the distance measurement signal of the distance measurer, and in a case where a distance to the subject in the first imaging is r_old, the shortest distance or the longest distance is r, and a threshold value which is a determination criterion for the allowable range of the spatial resolution is th, determine that the spatial resolution of the captured image does not fall within the allowable range in a case where |r−r_old|>th.

According to a tenth aspect of the present invention, in the imaging apparatus according to the seventh aspect, it is preferable that the first imaging is imaging in which a focusing position and a focal length of the camera are adjusted for the first region, and the second imaging is imaging in which the focusing position and the focal length of the camera are adjusted for the second region.

According to an eleventh aspect of the present invention, in the imaging apparatus according to the seventh aspect, it is preferable that the processor is configured to cause the camera to execute the first imaging for the imaging range during the movement of the camera in the first direction, and cause the camera to execute the second imaging during the movement of the camera in the first direction after the first imaging is ended and then the camera returns to at least a position at which re-imaging of the imaging range is possible.

According to a twelfth aspect of the present invention, in the imaging apparatus according to the eleventh aspect, it is preferable that the processor is configured to automatically adjust a focusing position and a focal length of the camera based on a distance to the subject in correspondence with the second region, or output, to an indicator, an instruction to prompt a user to adjust at least one of the focusing position or the focal length of the camera, before the camera returns to the position at which the re-imaging is possible, and execute the second imaging after the automatic adjustment or after the user adjusts at least one of the focusing position or the focal length of the camera.

According to a thirteenth aspect of the present invention, the imaging apparatus according to any one of the fourth aspect, the fifth aspect, the seventh aspect, and the tenth to twelfth aspects, it is preferable that a positioning meter that measures a position of the camera is further provided, in which the processor is configured to cause the camera to move in a second direction opposite to the first direction in a case where the first imaging for the imaging range is ended, and cause the camera to move again in the first direction in a case where detection is made that the camera returns to at least a position at which re-imaging of the imaging range is possible during the movement of the camera in the second direction based on a positioning signal of the positioning meter, and cause the camera to execute the second imaging for the imaging range.

According to a fourteenth aspect of the present invention, in the imaging apparatus according to any one of the fourth aspect, the fifth aspect, the seventh aspect, and the tenth to thirteenth aspects, it is preferable that a positioning meter that measures a position of the camera in a movement direction, and an indicator that instructs a user to perform a movement operation of the camera by the user are further provided, in which the processor is configured to output, to the indicator, an instruction to cause the camera to move in a second direction opposite to the first direction in a case where the first imaging for the imaging range is ended during the movement of the camera in the first direction, and output, to the indicator, an instruction to cause the camera to move again in the first direction in a case where detection is made that the camera returns to at least a position at which re-imaging of the imaging range is possible during the movement of the camera in the second direction based on a positioning signal of the positioning meter.

According to a fifteenth aspect of the present invention, in the imaging apparatus according to any one of the first to fourteenth aspects, it is preferable that the distance measurer is a laser distance measurer, and the laser distance measurer scans the subject with laser light to measure the distance in correspondence with the entire region of the captured image.

According to a sixteenth aspect of the present invention, in the imaging apparatus according to any one of the seventh aspect, and the tenth to twelfth aspects, it is preferable that the processor is configured to adjust a focusing position of the camera based on the distance measurement signal measured by the distance measurer, adjust the focusing position of the camera based on the distance measurement signal measured for the first region of the captured image in a case where the first imaging is executed, and adjust the focusing position of the camera based on the distance measurement signal measured for the second region of the captured image in a case where the second imaging is executed.

According to a seventeenth aspect of the present invention, in the imaging apparatus according to any one of the first to sixteenth aspects, it is preferable that the camera is configured of a plurality of second cameras, and the plurality of second cameras are disposed in an arc shape, a plurality of captured images captured by the plurality of second cameras include regions overlapping with each other, and the processor is configured to determine whether or not the target of interest is detectable from the captured image based on the distance measurement signal of the distance measurer for each captured image captured by each of the plurality of second cameras, and cause, to execute the first imaging and the second imaging, one or more cameras among the plurality of second cameras that have captured the captured image for which the determination is determined to be negative.

According to an eighteenth aspect of the present invention, in the imaging apparatus according to any one of the first to seventeenth aspects, it is preferable that the camera is configured of a first camera and a second camera, and the second camera is disposed at a position different from the first camera in a movement direction, which is behind the first camera by a distance equal to or larger than a length of the imaging range in the movement direction of the camera, and the processor is configured to cause the first camera to execute the first imaging, and cause the second camera to execute the second imaging for the imaging range.

According to a nineteenth aspect of the present invention, in the imaging apparatus according to any one of the seventh aspect, the tenth to twelfth aspects, and the sixteenth aspect, it is preferable that the processor is configured to perform panorama composition on the captured images, and the captured images used for the panorama composition of the imaging range are an image of the first region in the captured image by the first imaging and an image of the second region in the captured image by the second imaging.

According to a twentieth aspect of the present invention, there is provided an imaging method of an imaging apparatus including a camera, a distance measurer that measures a distance to a subject, and a processor, the imaging method executed by the processor including a step of causing the camera to execute first imaging in which split imaging is spatially performed on the subject to acquire a captured image, a step of determining whether or not a target of interest is detectable from the captured image based on a distance measurement signal of the distance measurer, and a step of causing the camera to execute second imaging, which has an imaging condition different from that of the first imaging, for an imaging range of the subject for which the determination is determined to be negative.

### BRIEF DESCRIPTION OF THE DRAWINGS

FIG. 1 is a diagram showing a state in which a camera mounted on a moving object that moves along a longitudinal direction of a subject continuously images the subject during the movement of the moving object.

FIG. 2 is a diagram showing a state in which the camera is moved from an imaging position shown in FIG. 1 to a next imaging position.

FIG. 3 is a diagram showing a state in which the camera is moved from the imaging position shown in FIG. 2 to a next imaging position.

FIG. 4 is a diagram showing a state in which the camera is moved from the imaging position shown in FIG. 3 to a next imaging position.

FIG. 5 is a diagram showing a state in which the camera is moved from the imaging position shown in FIG. 4 to a next imaging position.

FIG. 6 is a diagram showing a state in which the camera is in the same imaging position as that of the camera shown in FIG. 5, but an imaging condition of the camera is reset.

FIG. 7 is a diagram showing a state in which the camera returns to a predetermined position from the imaging position shown in FIG. 6.

FIG. 8 is a diagram showing a positional relationship between the camera and a distance measurer, an imaging range of the camera, and the like.

FIG. 9 is another diagram showing the positional relationship between the camera and the distance measurer, the imaging range of the camera, and the like.

FIG. 10 is a diagram showing a positional relationship between respective parts in a case where a positioning meter is mounted on a carriage.

FIG. 11 is a configuration diagram showing a first embodiment of the imaging apparatus according to the present invention.

FIG. 12 is a block diagram showing an embodiment of a hardware configuration of a control device shown in FIG. 11.

FIG. 13 is a timing chart showing an example of an imaging operation by the imaging apparatus of the first embodiment.

FIG. 14 is a diagram showing another embodiment of the camera.

FIG. 15 is a configuration diagram showing a second embodiment of the imaging apparatus according to the present invention.

FIG. 16 is a configuration diagram of a main part showing a third embodiment of the imaging apparatus according to the present invention.

FIG. 17 is a diagram showing a part of a flowchart showing an embodiment of an imaging method according to the present invention.

FIG. 18 is a diagram showing a continuation of the flowchart shown in FIG. 17.

FIG. 19 is a diagram showing a continuation of the flowchart shown in FIG. 17.

FIGS. 20A and 20B are diagrams showing an example of a captured image of a portion in which a diameter of a tunnel is largely changed.

### DESCRIPTION OF THE PREFERRED EMBODIMENTS

Hereinafter, preferred embodiments of an imaging apparatus and an imaging method according to the present invention will be described with reference to accompanying drawings.

### [Outline of Present Invention]

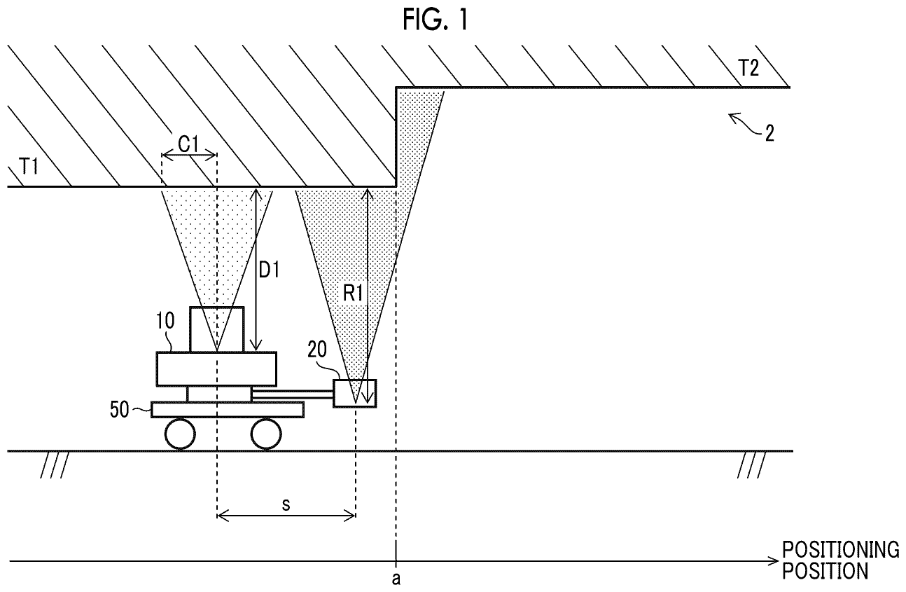

An outline of the present invention will be described with reference to FIGS. 1 to 7.

FIGS. 1 to 7 are diagrams showing states in which a camera mounted on a moving object that moves along a longitudinal direction of a subject continuously images the subject during the movement of the moving object, and positions of the moving object (camera) with respect to the subject are different.

The subject of the present example is a tunnel 2 of a railway, and the moving object is a carriage 50 that travels on a rail of the railway.

The carriage 50 is mounted with a camera 10, a distance measurer 20, and a control device (not shown).

The carriage 50 may be a self-traveling carriage that is controlled to move along the rail in a first direction (forward direction), stop, and a second direction (backward direction) in response to a command from the control device, or may be operated to move by human power.

The camera 10 can adjust a focusing position (focus position) and a focal length, and captures a static image at an interval of a constant time interval set during the traveling of the carriage 50, captures a static image for each set traveling distance, or captures a moving image. Accordingly, the camera 10 moving relatively to the tunnel 2 performs split imaging on the tunnel 2 spatially.

In a case where static images are sequentially captured, the interval or the like of the camera 10 is set such that preceding and succeeding captured images include regions overlapping with each other.

The distance measurer 20 is provided at a position in front of a position of the camera 10 (in the forward direction of the carriage 50) by a distance s, and measures a distance R to the tunnel 2 at the position.

In the present example, a light detection and ranging (LiDAR), which is one of laser distance measurers that measure a distance to a surface of a subject using laser light, is used as the distance measurer 20. The LiDAR includes a frequency modulated continuous wave (FMCW) type LiDAR, a time of flight (TOF) type LiDAR, and the like. Further, the distance measurer 20 is not limited to the LiDAR, and a laser radar three-dimensional shape measuring device described in JP1997-297014A (JP-H9-297014A), a measurement device using an optical cutting method with an imaging apparatus and a slit laser light projector described in JP2016-31249A, and the like may be employed, and the type of the distance measurer is not limited.

The distance measurer 20 causes laser light emitted from a measurement head to revolve to scan a wall surface with the laser light, and measures a distance between the measurement head and an irradiation position of the laser light on the wall surface of the tunnel 2.

Further, it is preferable that the distance measurer 20 converts the measured distance into a distance in the same direction as an optical axis of the camera 10 based on an angle formed by the optical axis of the camera 10 and the laser light. Further, the distance measurer 20 may emit the laser light in the same direction as the optical axis of the camera 10 without causing the laser light to revolve, or may measure the distance to the wall surface of the tunnel 2 in real time during the movement of the carriage 50.

Furthermore, the distance measurer 20 is disposed in front of the position of the camera 10 by the distance s, but the disposition position (distance s) of the distance measurer 20 can be randomly set, and for example, the distance measurer 20 may be disposed at a position where the distance s is zero. It is preferable that the distance measurer 20 is disposed at a position close to the camera 10 within a range not hindering the distance measurement.

At a position of the carriage 50 shown in FIG. 1, the camera 10 images a wall surface T1 of the tunnel 2. In this case, the focusing position and the focal length of the camera 10 are adjusted such that a spatial resolution of the wall surface T1 in the captured image falls within an allowable range. The allowable range of the spatial resolution is determined by the spatial resolution required for inspecting a damage state of a surface of a structure (the wall surface of the tunnel 2 in the present example). For example, the allowable range thereof is different between a case where fissuring with a fissuring width of 0.2 mm or more is required to be detected as the fissuring of the wall surface of the tunnel 2 and a case where fissuring with a fissuring width of 1.0 mm or more is required to be detected.

Further, it is preferable that the focal length of the camera 10 is short within a range in which the spatial resolution falls within the allowable range. This is because an area of the wall surface of the tunnel 2 that can be imaged at one time can be increased, and thus the wall surface can be efficiently imaged.

In FIG. 1, D1 is an imaging distance of the camera 10 (distance between the camera 10 and the wall surface T1 in the optical axis direction), and R1 is a distance to the wall surface T1 in the same direction as the optical axis of the camera 10 measured by the distance measurer 20.

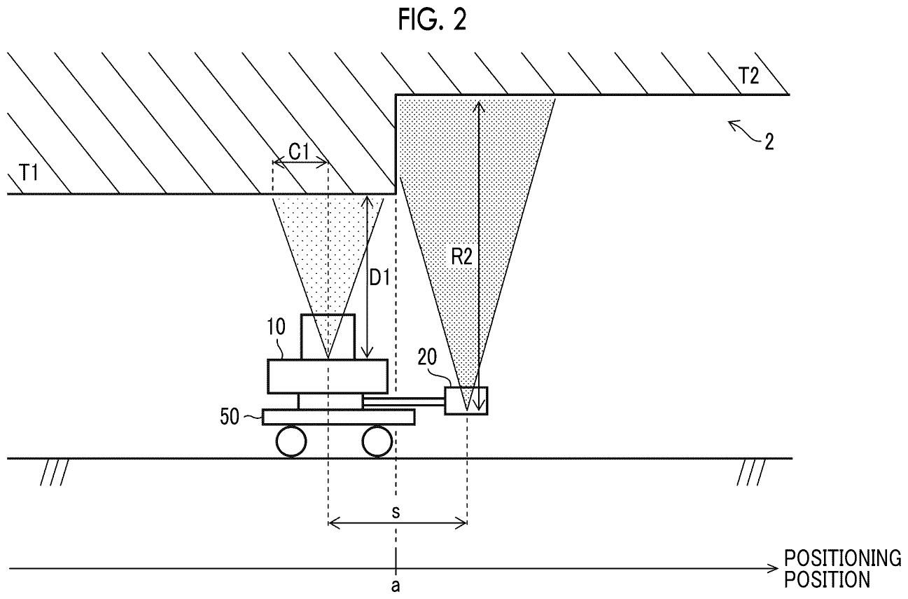

FIG. 2 is a diagram showing a state in which the camera is moved from the imaging position shown in FIG. 1 to a next imaging position.

That is, the camera 10 shown in FIG. 2 moves forward by a constant distance from the camera 10 shown in FIG. 1. In a case where the camera 10 performs the imaging at the interval of the constant time interval, the “constant distance” is determined by a speed of the carriage 50 and the constant time interval. In a case where an examiner (user) manually pushes the carriage 50 to cause the carriage 50 to move forward, the speed of the carriage 50 is a walking speed of the user. Further, in a case where the camera 10 repeatedly captures the static images each time the carriage 50 moves forward by a distance set in advance, the “constant distance” is the distance set in advance. In this case, the position of the carriage 50 is positioned by a positioning meter, and each time it is detected that the carriage 50 moves forward by the distance set in advance (constant distance), based on positioning data from the positioning meter, an imaging instruction is provided to the camera 10 to execute the imaging.

Further, it is preferable that the “constant distance” is determined such that the preceding and succeeding captured images, which are sequentially captured, include the regions overlapping with each other. The overlapping region of the captured images is used in a case where panorama composition is performed on the preceding and succeeding captured images. Since the captured image of the wall surface of the tunnel 2 has few portions serving as feature points used for the panorama composition, it is preferable that the overlapping region is sufficiently large.

In FIG. 2, the camera 10 images the wall surface T1 at the imaging distance D1 as in the case of FIG. 1, but the distance measurer 20 measures a distance R2 to a wall surface T2 farther than the wall surface T1.

In the case of the imaging position shown in FIG. 2, the camera 10 images only the wall surface T1 and does not image the wall surface T2. Further, in FIG. 2, a is a boundary position serving as a boundary between the wall surface T1 and the wall surface T2. The boundary position a can be acquired from the positioning meter that positions the position of the carriage 50 as will be described below. Furthermore, the boundary between the wall surface T1 and the wall surface T2 is not limited to a case where the boundary changes stepwise as shown in FIG. 2, and also includes a case where the boundary changes continuously with an inclined surface from the wall surface T1 to the wall surface T2.

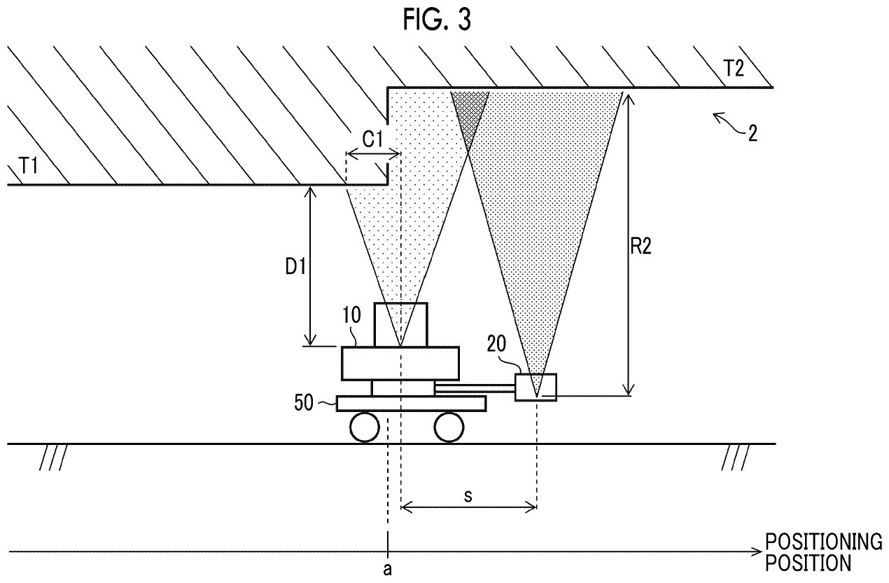

FIG. 3 is a diagram showing a state in which the camera is moved from the imaging position shown in FIG. 2 to a next imaging position.

An imaging range of the camera 10 at the imaging position shown in FIG. 3 includes the wall surface T1 and the wall surface T2. In the present example, the camera 10 repeatedly performs the imaging in a state in which the focusing position and the focal length are adjusted with respect to the wall surface T1. For this reason, the spatial resolution of the wall surface T1 included in the captured image is within the allowable range, but the spatial resolution of the wall surface T2 included in the captured image is not within the allowable range. That is, unless the focusing position and the focal length of the camera 10 are readjusted, the wall surface T2 of the present example is spaced from the wall surface T1 by a distance at which the spatial resolution of the wall surface T2 does not fall within the allowable range.

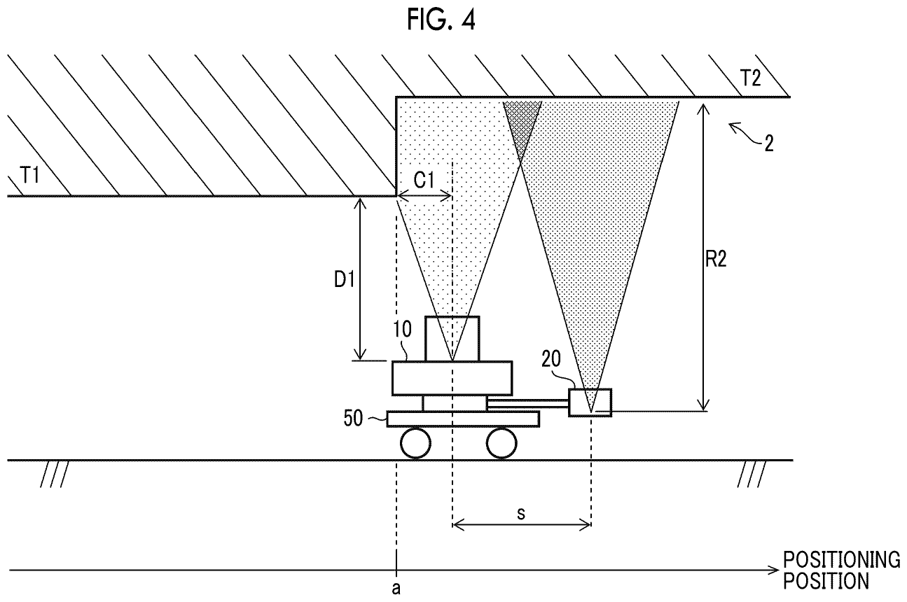

FIG. 4 is a diagram showing a state in which the camera is moved from the imaging position shown in FIG. 3 to a next imaging position.

The imaging range of the camera 10 shown in FIG. 4 does not include the wall surface T1, and includes the wall surface T2 and a wall surface of a boundary portion between the wall surface T1 and the wall surface T2. In the captured image in this case, since the wall surface of the boundary portion between the wall surface T1 and the wall surface T2 does not face the camera 10, it can be determined that the spatial resolution of a region in correspondence with the wall surface of the boundary portion does not fall within the allowable range. As a result, the spatial resolution of the entire region of the captured image does not fall within the allowable range.

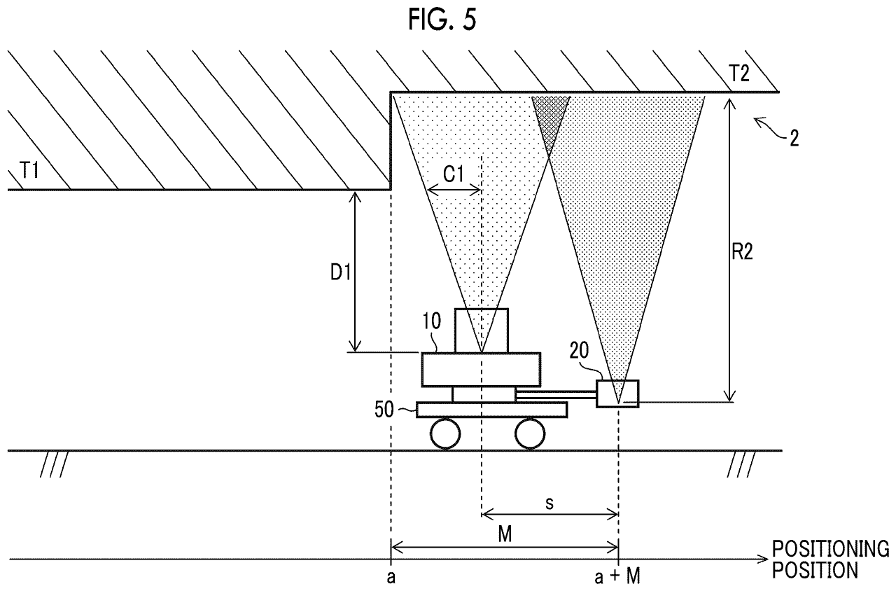

FIG. 5 is a diagram showing a state in which the camera is moved from the imaging position shown in FIG. 4 to a next imaging position.

The imaging range of the camera 10 shown in FIG. 5 includes only the wall surface T2. Therefore, in the captured image in this case, the spatial resolution of the entire region of the captured image does not fall within the allowable range as in the case of FIG. 4.

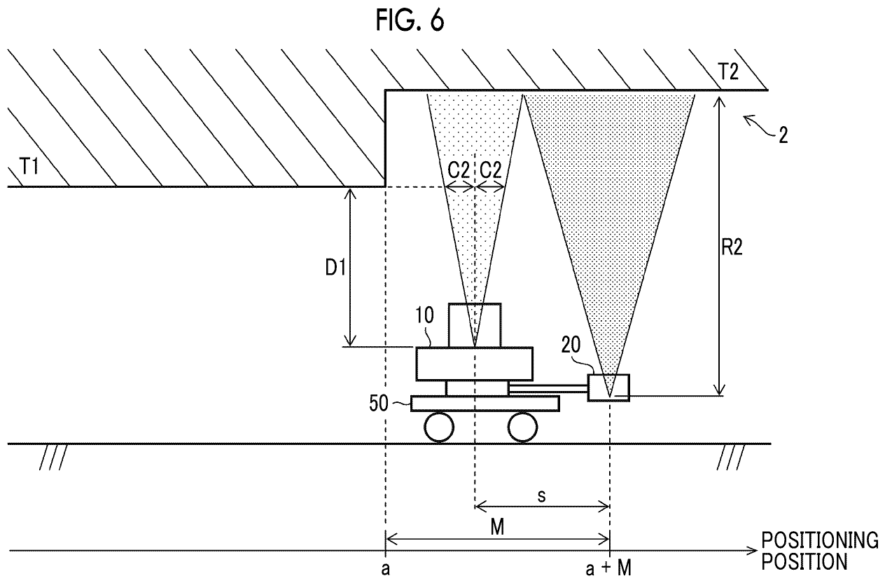

FIG. 6 is a diagram showing a state in which the camera is in the same imaging position as that of the camera 10 shown in FIG. 5, but an imaging condition of the camera is reset.

In an embodiment of the present invention, in a case where the camera 10 reaches the position shown in FIG. 6, the carriage 50 is caused to be temporarily stopped. In the present example, the camera 10 is caused to be stopped at the position where only the wall surface T2 is imaged.

In the camera 10, the focusing position is adjusted such that the focusing position of the camera 10 is the wall surface T2 during the temporary stop, and the focal length of the camera 10 is adjusted such that an imaging angle of view is narrowed.

In the case of the present example, the wall surface T2 is farther than the wall surface T1, and as a result, the spatial resolution of the wall surface T2 does not fall within the allowable range. For this reason, in order to obtain the captured image having a high spatial resolution for the wall surface T2, it is necessary to increase the focal length of a lens 11 of the camera 10 and narrow the imaging angle of view for increasing the number of pixels of an imaging element 12 of the camera 10 per unit length of the wall surface T2 (increasing the resolution of the captured image).

For example, from the imaging distance of the subject, performance (size of imaging element 12, the number of pixels, lens performance, and the like) of the camera 10, a required spatial resolution, and the like, an optimal focal length of the camera 10 satisfying the required spatial resolution is calculated by a calculation formula, and the focal length of the lens 11 of the camera 10 can be adjusted to the calculated focal length. Further, with use of a look-up table in which a relationship between the imaging distance of the subject and the optimal focal length is registered, in a case where the focal length of the camera 10 is adjusted, it is conceivable that a corresponding focal length is read out from the look-up table based on the imaging distance of the subject and the focal length is adjusted to the readout focal length. The adjustment of the focal length of the camera 10 may be automatically performed by an electrical power or may be manually performed by an operation of a zoom ring or the like.

Further, the focus position of the lens 11 of the camera 10 can be adjusted by a method of automatically performing the adjustment using a distance measurement signal (distance measurement data) of the distance measurer 20, a method of performing the adjustment using an autofocus function provided in the camera 10, or a method of manually performing the adjustment by an operation of a focus ring or the like. Since the focusing position and the focal length of the camera 10 are adjusted during the temporary stop of the carriage 50, it is possible to accurately adjust the focusing position and the focal length.

In FIG. 6, R2 is a distance, which is measured by the distance measurer 20, to the wall surface T2 in the same direction as the optical axis of the camera 10. Further, C2 indicates half of a width of the imaging range at the same distance as the wall surface T1 after the focal length of the lens 11 of the camera 10 is adjusted in correspondence with the distance to the wall surface T2.

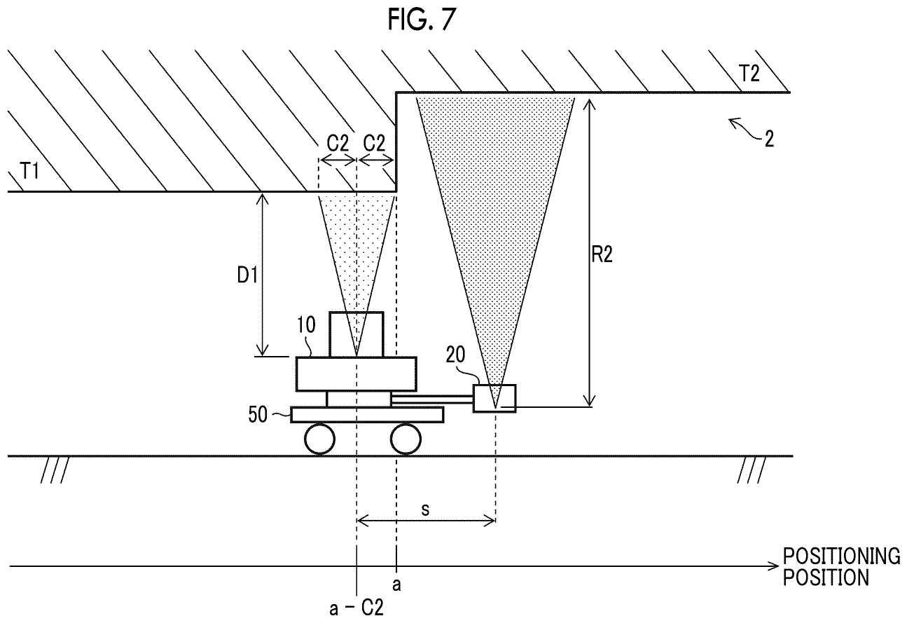

In an embodiment of the present invention, the carriage 50 is caused to be temporarily stopped at the imaging position shown in FIG. 6, and the focus position and the focal length of the camera 10 are adjusted with respect to the wall surface T2. Thereafter, the carriage 50 is caused to travel in a direction opposite to the forward direction (backward direction) and is returned to a position where the camera 10 can image the wall surface T1 as shown in FIG. 7.

FIG. 7 is a diagram showing a state in which the camera returns to a predetermined position from the imaging position shown in FIG. 6.

As shown in FIG. 7, the optical axis (imaging position) of the camera 10 is located at a position behind, by the distance C2, the boundary position a between the wall surface T1 and the wall surface T2 (to left direction in FIG. 7). The camera 10 that has returned to the position images only the wall surface T1.

Since the focusing position of the camera 10 is adjusted to focus on the wall surface T2, the captured image of the wall surface T1, which is captured by the camera 10 at the imaging position shown in FIG. 7, is out of focus. That is, it is considered that the spatial resolution of the wall surface T1 included in the captured image, which is captured at the imaging position shown in FIG. 7, exceeds the allowable range.

Thereafter, the carriage 50 starts moving again in the forward direction and also starts the imaging with the camera 10. In a case where the imaging range of the camera 10 includes the wall surfaces T1 and T2, the spatial resolution of a region in correspondence with the wall surface T2 in the captured image falls within the allowable range. Further, even in a case where the camera 10 images only the wall surface T2, the spatial resolution of the wall surface T2 in the captured image falls within the allowable range. This is because the focus position and the focal length of the camera 10 are adjusted with respect to the wall surface T2 in advance.

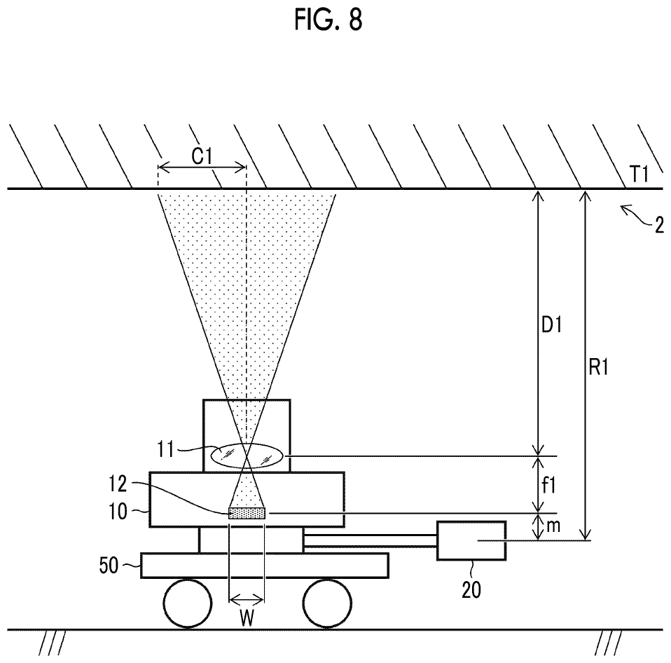

FIG. 8 is a diagram showing a positional relationship between the camera and the distance measurer, the imaging range of the camera, and the like.

In FIG. 8, the focal length of the lens 11 of the camera 10 is represented by f1, a width of the imaging element 12 is represented by W, and the imaging distance of the wall surface T1 is represented by D1. Further, C1 is an index indicating how far the camera 10 can perform the imaging from a position corresponding to a center of the captured image of the wall surface T1, and corresponds to a length of a half width of the wall surface T1 imaged by the camera 10.

From a geometric relationship, the focal length f1 of the lens 11 of the camera 10, the width W of the imaging element 12, the imaging distance D1 of the wall surface T1, and the length C1 of the half width of the wall surface T1 imaged by the camera 10 satisfy the following equation

C1:D1=W/2:f1 [Formula 1]

In a case where [Formula 1] is modified, C1 can be represented by the following equation.

C1=D1×(W/2)×1/f1

=(R1−f1−m)×(W/2)×1/f1 [Formula 2]

In a case where a distance measured by the distance measurer 20 is R1 and a distance in the optical axis direction of the lens 11 between the distance measurer 20 and the imaging element 12 is m, the imaging distance D1 can be represented by D1=R1−f1−m.

The spatial resolution is evaluated by the number of line pairs of light and shade that can be resolved per length of 1 mm. Since the number of pixels of the imaging element 12 is determined by the performance of the camera 10, the spatial resolution is higher as C1 is shorter.

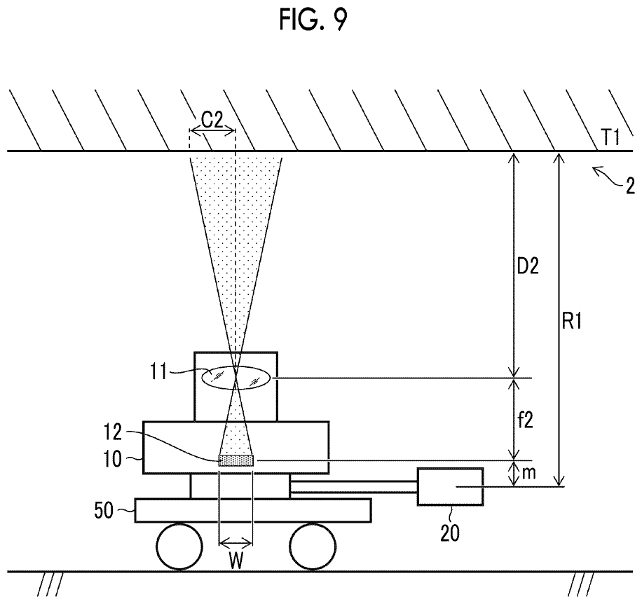

FIG. 9 is another diagram showing the positional relationship between the camera and the distance measurer, the imaging range of the camera, and the like, and the focal length of the camera shown in FIG. 9 is adjusted to be longer than the focal length of the camera shown in FIG. 8.

In FIG. 9, in a case where the focal length of the lens 11 of the camera 10 is f2, the width of the imaging element 12 is W, and the imaging distance of the wall surface T1 is D2, a length C2 of a half width of the imaging range of the wall surface T1 imaged by the camera 10 after the focus adjustment can be obtained by the following equation, in the same manner as in the equation of [Formula 2].

C2=D2·W/(2f2)

=(R1−f2−m)×(W/2)×1/f2 [Formula 3]

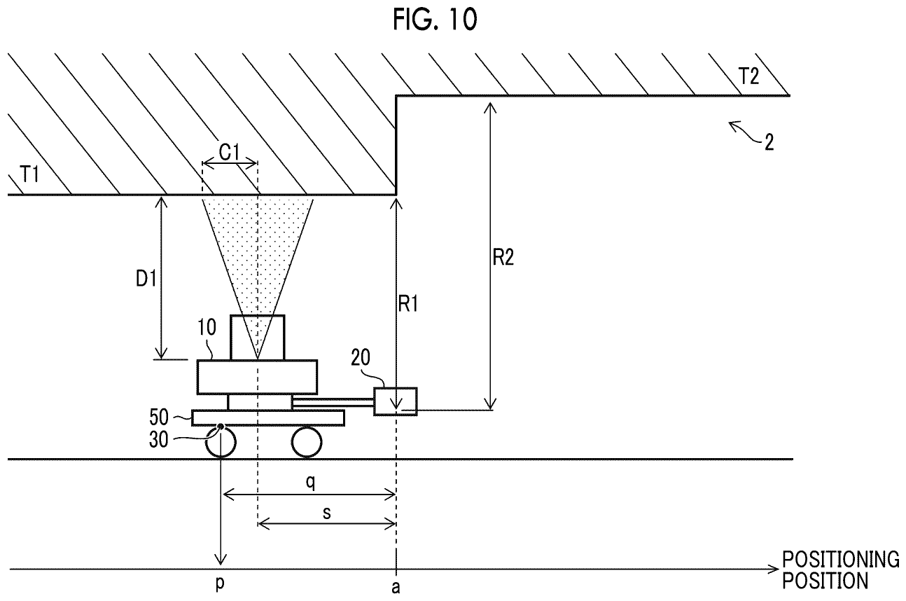

FIG. 10 is a diagram showing a positional relationship between respective parts in a case where the positioning meter is mounted on the carriage.

In FIG. 10, a positioning meter 30 can use, for example, a rotary encoder that integrates pulse signals generated according to rotation of wheels of the carriage 50 from a positioning start position and converts an integrated value into a distance to perform the positioning of the position of the carriage 50.

As shown in FIG. 10, in a case where a distance (spacing) between the distance measurer 20 and the positioning meter 30 in a traveling direction of the carriage 50 is q, and a position of the distance measurer 20 is at the boundary position a between the wall surface T1 and the wall surface T2, and a positioning position of the carriage 50 measured by the positioning meter 30 is p, the boundary position a can be represented by the following equation.

a=p+q [Formula 4]

Further, a positioning position of the camera 10 in the traveling direction (imaging position) can also be obtained from the positioning position p measured by the positioning meter 30. It is preferable that the camera 10 adds information indicating the imaging position obtained from the positioning position p of the positioning meter 30, as additional information of the captured image. It is possible to use the information indicating the imaging position in a case where the panorama composition is performed on the captured images that are sequentially captured.

### [First Embodiment of Imaging Apparatus]

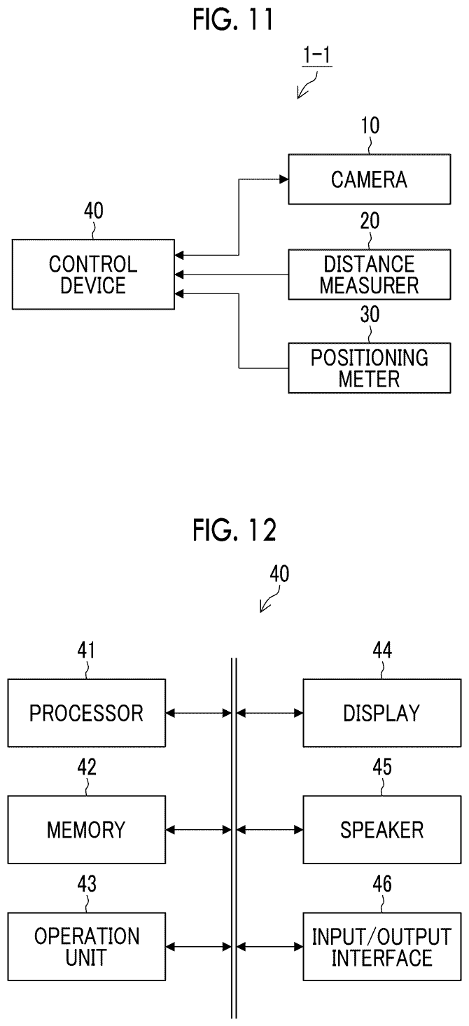

FIG. 11 is a configuration diagram showing a first embodiment of the imaging apparatus according to the present invention.

An imaging apparatus 1-1 of the first embodiment shown in FIG. 11 is configured of the camera 10, the distance measurer 20, the positioning meter 30, which are shown in FIG. 10, and a control device 40.

The control device 40 receives the distance measurement data indicating the distance to the wall surface of the tunnel 2, which is measured by the distance measurer 20, and a positioning signal (positioning data) indicating the position p of the carriage 50 in the traveling direction, which is positioned by the positioning meter 30, and executes an imaging operation, the setting of the imaging condition, and the like of the camera 10.

FIG. 12 is a block diagram showing an embodiment of a hardware configuration of the control device shown in FIG. 11.

A control device 40 shown in FIG. 12 is configured of a personal computer, a workstation, or the like, and comprises a processor 41, a memory 42, an operation unit 43, a display 44, a speaker 45, and an input/output interface 46. Since the control device 40 is mounted on the carriage 50, together with the camera 10 and the like, and is caused to move, a laptop computer is suitable.

The processor 41 is configured of a central processing unit (CPU) or the like, and integrally controls respective parts of the control device 40 and controls the camera 10. Details of various types of processing performed by the processor 41 will be described below.

The memory 42 includes a flash memory, a read-only memory (ROM), a random access memory (RAM), a hard disk device, and the like. The flash memory, the ROM, or the hard disk device is a non-volatile memory that stores an operating system, various programs including a program for causing the imaging method according to the embodiment of the present invention to execute, and the like. Further, the non-volatile memory, such as the flash memory and the hard disk device, stores imaging performance information of the camera 10, information indicating a positional relationship between the camera 10, the distance measurer 20, and the positioning meter 30 mounted on the carriage 50, and the like.

The RAM functions as a work area for processing by the processor 41. Further, various programs stored in a flash memory or the like, data used for calculation processing, and the like are temporarily stored. A part (RAM) of the memory 42 may be built into the processor 41.

The operation unit 43, the display 44, and the speaker 45 are used as a user interface. In a case where the control device 40 is configured of the laptop computer, the operation unit 43 is a keyboard, a touch pad, a mouse, or the like of the laptop computer. The display 44 displays a screen for operation and notifies the user of necessary information by character information or the like, and the speaker 45 notifies the user of necessary information by voice.

The input/output interface 46 includes a connection unit that is connectable to an external device, a communication unit that is connectable to a network, and the like. A universal serial bus (USB), a high-definition multimedia interface (HDMI) (HDMI is a registered trademark), or the like can be employed as the connection unit that is connectable to the external device.

In the present example, the camera 10, the distance measurer 20, and the positioning meter 30 are connected to the input/output interface 46, and the processor 41 acquires the distance measurement data and the positioning data from the distance measurer 20 and the positioning meter 30 via the input/output interface 46, causes the imaging operation, the setting of the imaging condition, and the like of the camera 10 to execute, or provides the user with necessary information via an indicator (the display 44 and the speaker 45).

### <Imaging Operation by Imaging Apparatus>

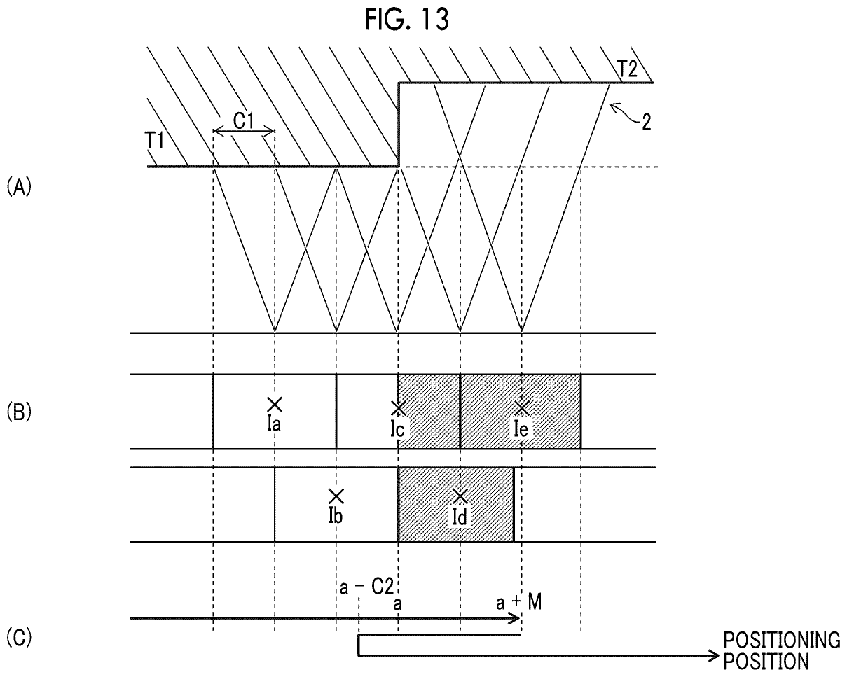

FIG. 13 is a timing chart showing an example of the imaging operation by the imaging apparatus of the first embodiment.

In the case of the imaging apparatus 1-1 according to the first embodiment, it is assumed that the user manually pushes to cause the carriage 50 to move on the rail of the railway in the forward direction at a constant speed, and the user manually adjusts the focus position and the focal length of the lens 11 of the camera 10. The “constant speed” is a speed at which the user manually pushes the carriage 50, and thus is determined by the walking speed of the user.

(A) of FIG. 13 is a diagram schematically showing the imaging position and the imaging range of the camera 10 shown in FIGS. 1 to 5.

In (A) of FIG. 13, in a case where the camera 10 receives an instruction to start the imaging from the control device 40 (processor 41), the camera 10 continuously captures static images at an interval of a constant time interval until an instruction to temporarily stop the imaging or an instruction to end the imaging is received.

In the example shown in FIG. 13, a movement distance of the carriage 50 (camera 10) that moves during the constant time interval corresponds to the length C1 of the half width of the imaging range of the wall surface T1 by the camera 10. Therefore, preceding and succeeding captured images, which are captured at respective imaging positions, are captured with an overlap rate of 50% or more.

Although there is a variation in the speed at which the user walks while pushing the carriage 50, the movement distance of the carriage 50 that moves during the constant time interval can be made substantially constant. Further, in a case where the static image is captured each time the carriage 50 moves in the forward direction by a certain distance, the processor 41 can determine whether or not the carriage 50 has moved forward by the certain distance from a previous imaging position based on the positioning data from the positioning meter 30, to issue the imaging instruction for the static image.

(B) of FIG. 13 is an image diagram of five captured images Ia to Ie, which are captured at respective imaging positions.

In a case where the carriage 50 moves in the forward direction (from left to right in FIG. 13), the distance measurer 20 measures the distance to the wall surface in advance by the distance s with respect to the position of the camera 10 (refer to FIG. 1), and thus the processor 41 can acquire the distance to the wall surface in correspondence with the captured image captured by the camera 10 based on the distance measurement data from the distance measurer 20.

In a case where the distance R2 to the wall surface in correspondence with a current captured image is changed by a value equal to or larger than a threshold value th, which is a determination criterion for the allowable range, from the distance R1 to the wall surface in correspondence with the captured image in previous imaging (|R2−R1|≥th), the spatial resolution of the current captured image does not fall within the allowable range, and thus it is necessary to change the imaging condition (focus position and focal length of the lens 11 of the camera 10) in the previous imaging of the camera 10. An absolute value (|R2−R1|) of a difference in distance between the wall surface T1 and the wall surface T2 in the present example is equal to or larger than the threshold value th.

At a point in time at which the change in distance is detected to be equal to or larger than the threshold value, the captured images captured by the camera 10 include a case where only the wall surface T1 is imaged (FIG. 2), a case where the wall surface T1 and the wall surface T2 are imaged (FIG. 3), a case where the wall surface T2 and the wall surface of the boundary position a between the wall surface T1 and the wall surface T2 are imaged (FIG. 4), and a case where only the wall surface T2 is imaged (FIG. 5).

The wall surface T2 cannot be imaged clearly since the focus position and the focal length of the camera 10 are adjusted with respect to the wall surface T1. Regions indicated by diagonal lines in respective captured images Ia to Ie schematically shown in (B) of FIG. 13 are not regions in correspondence with the wall surface T1, and thus are not imaged clearly. That is, the captured images Ia and Ib are clearly imaged since only the wall surface T1 is imaged in the captured images Ia and Ib, and the spatial resolution of the captured images Ia and Ib is within the allowable range. On the other hand, the wall surface T1 and the wall surface T2 before and after the boundary position a are imaged in the captured image Ic, and the region in correspondence with the wall surface T2 is not imaged clearly. Further, the wall surface T1 is not imaged in the captured images Id and Ie, and the captured images Id and Ie are not imaged clearly over the entire region.

Therefore, in a case where the carriage 50 reaches the imaging position (imaging position where the wall surface T1 is no longer imaged) at which the captured image Ie of only the wall surface T2 is captured by the camera 10, the processor 41 outputs an instruction to stop the carriage 50 to the indicator (the display 44 and/or the speaker 45) and temporarily stops subsequent imaging.

The processor 41 can detect whether or not the captured image captured by the camera 10 includes the region of the wall surface T1 and the region of the wall surface T2 before and after the boundary position a, based on the distance measurement data measured by the distance measurer 20.

In a case where the captured image captured by the camera 10 is detected to include the region of the wall surface T1 and the region of the wall surface T2 before and after the boundary position a, and then, as shown in FIG. 5, in a case where the imaging position of the camera 10 reaches the imaging position that is moved, from the boundary position a, by the width C1 or more of half of the imaging range of the wall surface T1, the processor 41 outputs a command to stop the carriage 50 to the display 44 and the speaker 45. This is because the wall surface T1 is not included in the captured image captured at the imaging position moved, from the boundary position a, by the width C1 or more.

In a case where the position of the distance measurer 20 is located in front of the imaging position of the camera 10 by the distance s as shown in FIG. 5 and the position of the distance measurer 20 with respect to the boundary position a is (a+M), the wall surface T1 is not included in the captured image at the imaging position where M≥s+C1.

In a case where the wall surface T1 is determined not to be included in the captured image as described above, for example, the processor 41 outputs, to the display 44, a command to display a text display of “Please stop carriage”, and outputs, to the speaker 45, a command to generate a voice for notification of the stop of the carriage 50.

In a case where the user is notified of the stop of the carriage 50 by the display 44 and the speaker 45, the user immediately causes the carriage 50 to stop. Due to a delay in the stop operation of the carriage 50 by the user, the carriage 50 may have moved forward before a point in time at which the processor 41 outputs the stop command.

Subsequently, the processor 41 outputs, during a stop period of the carriage 50, a command to prompt the adjustment of the focus position and the focal length of the camera 10 to the indicator (the display 44 and the speaker 45) such that the spatial resolution of the region in correspondence with the wall surface T2 in the captured image falls within the allowable range.

In response to the command to prompt the adjustment of the focus position and the focal length of the camera 10, the user manually operates the focus ring of the camera 10 to adjust the focus position of the camera 10 while viewing a live view image or the like captured by the camera 10, and manually operates the zoom ring to adjust the focal length of the camera 10. It is preferable that the processor 41 causes the display 44 to display information indicating the focal length of the camera 10 that is optimal for the distance to the wall surface T2. Further, the focus position in the stop period of the camera 10 may be automatically adjusted based on the distance to the wall surface T2 measured by the distance measurer 20, or may be adjusted by the autofocus function provided in the camera 10.

In a case where the adjustment of the focus position and the focal length of the camera 10 by the user is ended (refer to FIG. 6), the processor 41 outputs, to the display 44, a command to return the carriage 50.

(C) of FIG. 13 is a diagram showing a traveling direction including forward and backward movement of the carriage 50.

It is preferable that the processor 41 outputs, to the display 44, distance information indicating a difference between a current position of the camera 10 and a position (a-C2) such that the imaging position of the camera 10 is a position (a-C2), based on the positioning data from the positioning meter 30.

In this case, the user may move the carriage 50 backward such that the distance information displayed on the display 44 is zero, and in a case where the distance information is zero, the position of the camera 10 is the position (a-C2) at which a specific imaging range can be imaged again as shown in FIG. 7.

In a case where the user returns the carriage 50 such that the imaging position of the camera 10 is the position (a-C2) at which the specific imaging range can be imaged again, the processor 41 resumes the imaging by the camera 10, and the user causes the carriage 50 to move again in the forward direction.

In a case where the camera 10 returns to the imaging position (a-C2) as described above, the captured image captured at the imaging position (a-C2) is an unclear image since the focus position of the camera 10 is out of focus for the wall surface T1.

Thereafter, in a case where the carriage 50 is moved in the forward direction and the wall surface T2 is imaged by the camera 10, the focus position and the focal length of the camera 10 are adjusted with respect to the wall surface T2. Therefore, the camera 10 can immediately image the clear wall surface T2, and it is possible to cause the spatial resolution of the wall surface T2 in the captured image to fall within the allowable range.

According to the first embodiment, the processor 41 determines whether or not the spatial resolution of the captured image falls within the allowable range based on the distance measurement signal of the distance measurer 20. In a case where the spatial resolution thereof is determined not to fall within the allowable range, the processor 41 causes the camera 10 to execute second imaging (imaging in which the imaging condition is set for the wall surface T2) having the imaging condition different from first imaging (imaging in which the imaging condition is set for the wall surface T1) for the specific imaging range (imaging range where the imaging position of the camera 10 is returned to perform the imaging again) of the wall surface for which the spatial resolution does not fall within the allowable range.

In this case, in the first imaging, the spatial resolution of the region in correspondence with the wall surface T1 in the captured image (first region) falls within the allowable range and the spatial resolution of the region in correspondence with the wall surface T2 in the captured image (second region) does not fall within the allowable range. On the other hand, in the second imaging, the spatial resolution of the first region in correspondence with the wall surface T1 in the captured image does not fall within the allowable range and the spatial resolution of the second region in correspondence with the wall surface T2 in the captured image falls within the allowable range.

Accordingly, imaging targets are the wall surface T1 and the wall surface T2 whose absolute value (|R2−R1|) of the difference in distance between the wall surface T1 and the wall surface T2 is equal to or larger than the threshold value th, and in the specific imaging range in which at least the wall surface T1 and the wall surface T2 are simultaneously imaged, two imaging operations of the first imaging and the second imaging with different imaging conditions are performed. As a result, clear wall surfaces T1 and T2 are always imaged in one of two captured images including the same wall surface T1 and two captured images including the same wall surface T2, which are captured twice.

In a case where the imaging of the tunnel 2 is ended or during the imaging, the processor 41 performs the panorama composition using the preceding and succeeding captured images in a movement direction of the camera 10. The panorama composition can be performed by extracting a plurality of feature points from respective overlapping regions of the preceding and succeeding captured images, and performing registration of the preceding and succeeding captured images such that the extracted plurality of feature points match. In a case where the information indicating the imaging position obtained from the positioning data of the positioning meter 30 is added as the additional information of each captured image, it is preferable to perform rough registration of the preceding and succeeding captured images using the information indicating the imaging position, and then to perform high-accuracy registration by the extraction of the plurality of feature points.

Further, in the specific imaging range in which the wall surface T1 and the wall surface T2 are simultaneously imaged, two imaging operations of the first imaging and the second imaging having different imaging conditions are performed to acquire two captured images for the same wall surface T1 or T2. However, it is preferable that the processor 41 uses only an image having the clearly imaged region in the two captured images as the captured image used for the panorama composition. Further, even in a case where there is a discontinuous portion such as the boundary position a between the wall surface T1 and the wall surface T2, it is possible to appropriately perform the registration of the preceding and succeeding captured images by using the information indicating the imaging position.

In the imaging operation by the imaging apparatus 1-1, a case has been described in which the carriage 50 is moved in the forward direction and the imaging of the wall surface T1 transitions to the imaging of the wall surface T2 farther than the wall surface T1, but the same imaging operation is also performed in a case where the carriage 50 is moved in the forward direction and the imaging of the wall surface T2 transitions to the imaging of the wall surface T1 (or wall surface closer than the wall surface T2).

Further, in the present example, the processor 41 detects whether or not the absolute value (|R2−R1|) of the difference in distance between the wall surface T1 and the wall surface T2 is equal to or larger than the threshold value th, and determines, with the detection, whether or not a target of interest (for example, fissuring having desired fissuring width) can be detected from the captured image, but the present invention is not limited thereto. The processor 41 may estimate (calculate) the spatial resolution of the captured image, based on imaging setting values, such as a current focal length of the camera 10 and the performance (size and the number of pixels of the imaging element 12) of the camera 10, and the distance measurement signal of the distance measurer 20, and determine whether or not the calculated spatial resolution falls within the allowable range to determine whether or not the target of interest can be detected from the captured image.

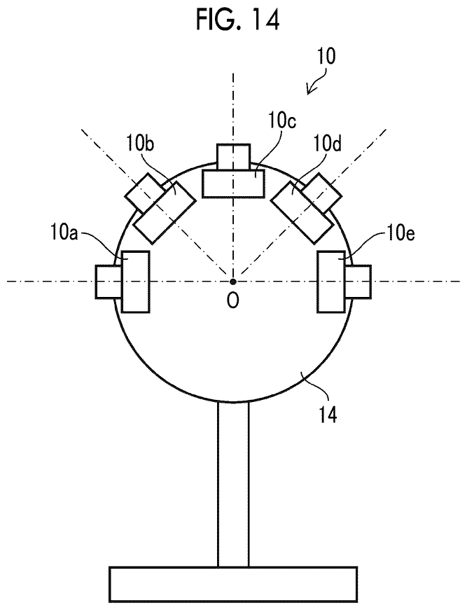

FIG. 14 is a diagram showing another embodiment of the camera.

The camera 10 shown in FIG. 14 is configured of a plurality (five) of second cameras 10a to 10e. The five second cameras 10a to 10e are disposed in an arc shape at equal distances from a reference position (center) O of a camera attachment member 14.

The carriage 50 is attached with the camera attachment member 14 to which the second cameras 10a to 10e shown in FIG. 14 are attached. Optical axes of the five second cameras 10a to 10e are disposed radially from the center O of the camera attachment member 14, and imaging directions of the five second cameras 10a to 10e are different from each other. The second cameras 10a to 10e simultaneously image an inner peripheral surface of the tunnel. It is preferable that the second cameras 10a to 10e are disposed such that adjacent captured images among a plurality of captured images, which are captured by the second cameras 10a to 10e, have regions overlapping with each other.

In a case where the plurality of second cameras 10a to 10e are mounted on the carriage 50 in this manner, it is preferable that the distance measurer 20 measures a distance in the entire circumferential direction of the tunnel by rotating laser light.

In a case where the plurality of second cameras 10a to 10e image the inner peripheral surface of the tunnel, there are a camera in which the distance to the wall surface in the captured image changes by a threshold value or more and a camera in which the distance does not change. In this case, in a case where the distance to the wall surface in the captured image of even one camera changes by the threshold value or more, the carriage 50 is stopped (the imaging condition is changed)→is moved backward→is stopped→is moved forward (the imaging is resumed) as described above. However, for the camera in which the distance to the wall surface in the captured image does not change by the threshold value or more, there is no need to change the imaging condition or to image the same imaging range twice.

### [Second Embodiment of Imaging Apparatus]

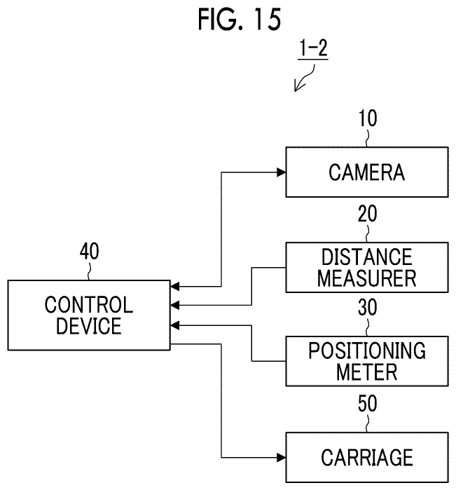

FIG. 15 is a configuration diagram showing a second embodiment of the imaging apparatus according to the present invention.

An imaging apparatus 1-2 of the second embodiment shown in FIG. 15 is configured of the camera 10, the distance measurer 20, the positioning meter 30, the control device 40, and the carriage 50, which are shown in FIG. 10. The same reference numerals are assigned to portions common to the imaging apparatus 1-1 of the first embodiment shown in FIG. 11, and a detailed description thereof will be omitted.

In a case of the imaging apparatus 1-1 of the first embodiment, the user manually pushes to cause the carriage 50 to move on the rail of the railway. However, a case of the imaging apparatus 1-2 of the second embodiment is different from that of the first embodiment in that the carriage 50 is a self-traveling type and the control device 40 (processor 41) controls the movement (moving forward, stopping, moving backward, moving speed, and the like) of the carriage 50.

In FIG. 13, the processor 41 of the control device 40 shown in FIG. 15 outputs, to the carriage 50, a movement command for causing the carriage 50 to move at a constant speed in the forward direction (from left to right in FIG. 13) to cause the carriage 50 to move.

Further, the processor 41 instructs the camera 10 to start the imaging and causes the camera 10 to execute the interval imaging having the constant time interval. With the movement control of the carriage 50 and the interval imaging of the camera 10, the captured images Ia to Ie are captured at respective imaging positions ((B) of FIG. 13).

In this case, since the focus position and the focal length of the camera 10 are adjusted for the wall surface T1, in a case where detection is made that the carriage 50 has reached the imaging position at which the camera 10 images the captured image Ie of only the wall surface T2 (imaging position at which the wall surface T1 is no longer imaged), the processor 41 outputs, to the carriage 50, an instruction to stop the carriage 50 to cause the carriage 50 to stop.

The processor 41 automatically adjusts the focus position and the focal length of the camera 10 such that the spatial resolution for the wall surface T2 falls within the allowable range during the stop period of the carriage 50. The processor 41 may automatically adjust the focus position of the camera 10 to a focus position in correspondence with the distance to the wall surface T2 measured by the distance measurer 20, or may automatically adjust the focus position by enabling an operation of the autofocus function provided in the camera 10.

Further, the processor 41 can read out the focal length registered in advance in correspondence with the imaging distance of the subject from the look-up table, based on the imaging distance of the subject (distance to the wall surface T2 measured by the distance measurer 20), and can automatically adjust the focal length of the camera 10 to the readout focal length.

In a case where the adjustment of the focus position and the focal length of the camera 10 for the wall surface T2 during the stop period of the carriage 50 is ended, the processor 41 outputs, to the carriage 50, a command to move the stopped carriage 50 in the backward direction (left direction in FIG. 13) to cause the carriage 50 to move backward.

The processor 41 determines whether or not the current position of the camera 10 has reached the position (a-C2), based on the positioning data from the positioning meter 30 during the backward movement of the carriage 50, and causes the carriage 50 to stop in a case where determination is made that the current position of the camera 10 has reached the position (a-C2) (refer to (C) of FIG. 13).

Thereafter, the processor 41 causes the carriage 50 to move in the forward direction again, and resumes the imaging of the camera 10 including the imaging position (a-C2) of the camera 10.

The captured image captured at the imaging position (a-C2) is an unclear image since the focus position of the camera 10 is out of focus for the wall surface T1. However, after that, in a case where the carriage 50 is moved in the forward direction and the wall surface T2 is imaged by the camera 10, the focus position and the focal length of the camera 10 are adjusted for the wall surface T2. Therefore, it is possible to clearly image the wall surface T2 and to cause the spatial resolution of the wall surface T2 to fall within the allowable range.

According to the second embodiment, as in the first embodiment, in the specific imaging range in which at least the wall surface T1 and the wall surface T2 are simultaneously imaged, two imaging operations of the first imaging in which the spatial resolution of the wall surface T1 falls within the allowable range and the second imaging in which the spatial resolution of the wall surface T2 falls within the allowable range are performed. As a result, it is possible to acquire an image whose spatial resolution falls within the allowable range even for the preceding and succeeding wall surfaces T1 and T2 including the boundary position between the wall surface T1 and the wall surface T2.

In the second embodiment, the focus position and the focal length of the camera 10 are adjusted during the stop of the carriage 50, but may be adjusted at least until the carriage 50 is returned and the imaging is resumed. Further, the focus position and the focal length of the camera 10 performed during the stop of the carriage 50 are automatically adjusted, but at least one of the focus position or the focal length of the camera 10 may be manually adjusted by the user operating the camera 10.

### [Third Embodiment of Imaging Apparatus]

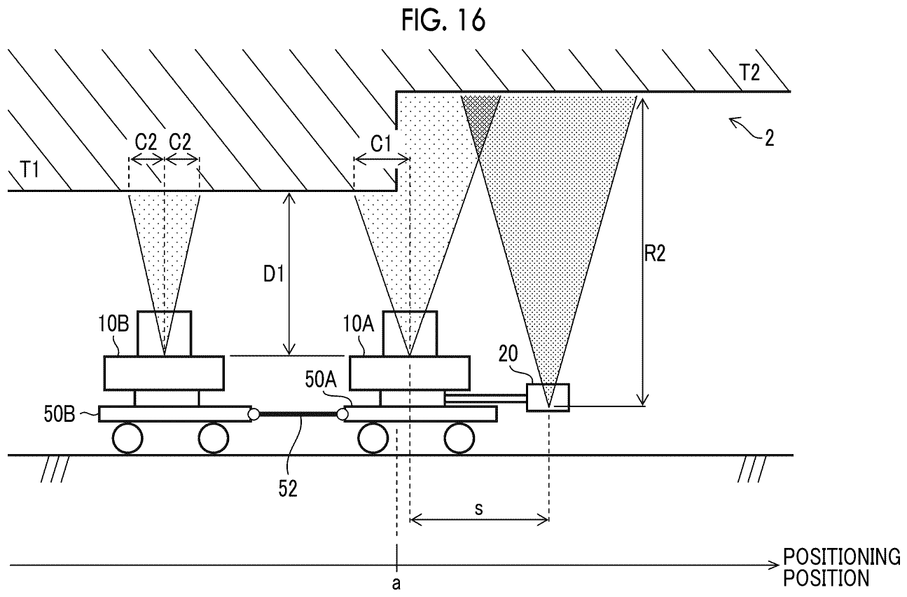

FIG. 16 is a configuration diagram of a main part showing a third embodiment of the imaging apparatus according to the present invention. The same reference numerals are assigned to portions common to the imaging apparatus 1-1 of the first embodiment, and a detailed description thereof will be omitted.

The imaging apparatus of the third embodiment shown in FIG. 16 is different from the imaging apparatus of the first embodiment and the second embodiment that perform the imaging again by returning the position of the carriage in that the carriage is moved only in the forward direction and the subject is imaged.

For this reason, the imaging apparatus of the third embodiment shown in FIG. 16 uses two carriages 50A and 50B, and the carriages 50A and 50B are respectively mounted with a first camera (camera 10A) and a second camera (camera 10B).

The carriage 50A and the carriage 50B are connected by a connection rod 52, and the camera 10A and the camera 10B are disposed at different positions of the carriage 50A and 50B in the movement direction with a constant spacing.

In a case where a range of the imaging position at which the front camera 10A can image the wall surface T1 and the wall surface T2 at the same time is set as the specific imaging range, the camera 10A and the camera 10B are disposed with a spacing equal to or larger than a length of the specific imaging range (length of the carriage 50A in movement direction). That is, the camera 10B is disposed at a position behind the camera 10A by a distance equal to or larger than the length of the specific imaging range. For example, in a case where the position of the camera 10A is moved forward of the boundary position a between the wall surface T1 and the wall surface T2 and first reaches the imaging position at which the wall surface T1 is not imaged, the camera 10B is disposed behind the camera 10A such that the camera 10B is at the imaging position at which only the wall surface T1 is imaged.

The processor 41 of the control device 40 configuring the imaging apparatus of the third embodiment causes the camera 10A to perform the interval imaging during the movement of the carriages 50A and 50B in the forward direction. That is, the processor 41 causes the camera 10A to execute the imaging in accordance with the imaging condition (the focus position and the focal length of the camera 10A) currently set in the camera 10A, regardless of the distances to the wall surfaces T1 and T2.

On the other hand, the processor 41 usually causes the imaging by the camera 10B to stop, but in a case where a certain condition is satisfied, the processor 41 adjusts the focus position and the focal length of the camera 10B and starts the interval imaging by the camera 10B.

In the present example, in a case where the camera 10A images only the wall surface T1 and then the processor 41 detects that the camera 10A has reached the imaging position at which the wall surface T1 and the wall surface T2 are imaged at the same time, based on the distance measurement data from the distance measurer 20, the processor 41 adjusts the focus position and the focal length of the camera 10B such that the spatial resolution of the wall surface T2 falls within the allowable range, and starts the interval imaging by the camera 10B.

Since the focus position and the focal length are adjusted for the wall surface T2 at a time of imaging start, the captured image of the wall surface T1 captured by the camera 10B is unclear, and the spatial resolution of the wall surface T1 exceeds the allowable range.

Thereafter, in a case where the carriages 50A and 50B are moved in the forward direction and the camera 10B makes the imaging of the wall surface T2, the spatial resolution of a portion in correspondence with the wall surface T2 in the captured image by the camera 10B falls within the allowable range. This is because the focus position and the focal length of the camera 10B are adjusted for the wall surface T2.

On the other hand, in a case where detection is made that the camera 10A images only the wall surface T2 based on the distance measurement data from the distance measurer 20, the processor 41 adjusts the focus position and the focal length of the camera 10A such that the spatial resolution of the wall surface T2 falls within the allowable range.

In a case where detection is made, from a relationship between a current imaging position of the camera 10B and a past imaging position of the camera 10A, that the carriages 50A and 50B are further moved in the forward direction, and the camera 10B images only the wall surface T2 and the imaging range of the camera 10B overlaps the imaging range of the camera 10A in which the focus position and the focal length are adjusted for the wall surface T2, the processor 41 stops the imaging of the wall surface T2 by the camera 10B. This is because there is no need to image the wall surface T2 at the same position with the two cameras 10A and 10B.

In the third embodiment, the carriages 50A and 50B are not stopped even during the adjustment of the focus positions and the focal lengths of the cameras 10A and 10B, but the processor 41 may employ only the captured image captured after a time required for the adjustment (after adjustment end). Further, one carriage may be used, instead of the two carriages 50A and 50B. In this case, a length of one carriage may be set to be the same as a length of the two carriages 50A and 50B connected to each other.

### [Imaging Method]

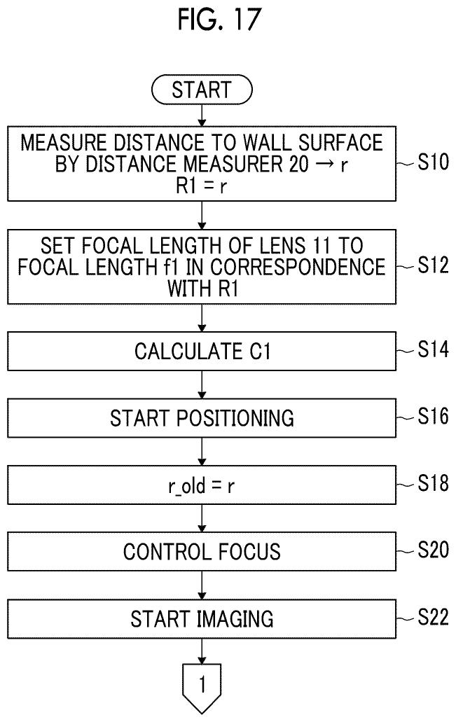

FIGS. 17 to 19 are flowcharts showing embodiments of the imaging method according to the present invention.

The imaging method shown in FIGS. 17 to 19 is performed by the processor 41 of the control device 40 shown in FIG. 12.

In FIG. 17, the processor 41 acquires a distance r to the wall surface of the tunnel measured by the distance measurer 20, and registers the distance r as the distance R1 (R1=r) (step S10).

Subsequently, the processor 41 adjusts the focal length of the lens 11 of the camera 10 to the focal length f1 in correspondence with R1 (step S12). The memory 42 stores the look-up table in which the relationship between the imaging distance of the subject and the optimal focal length at which the spatial resolution of the subject falls within the allowable range with respect to the imaging distance of the subject is registered, and the processor 41 reads out the focal length f1 in correspondence with the distance R1 from the look-up table to adjust the focal length of the lens 11 to the readout focal length f1. Further, the processor 41 may cause the display 44 to display the readout focal length f1, and the user may manually adjust the focal length of the lens 11 in accordance with the focal length f1 displayed on the display 44.

Subsequently, the processor 41 calculates the width C1 of half of the imaging range of the wall surface, based on the distance R1 and the focal length f1, by [Formula 2] described above (step S14). W in [Formula 2] is a size of the imaging element 12 of the camera 10 as shown in FIG. 8, m is a distance between the distance measurer 20 and the imaging element 12 in the optical axis direction of the lens 11, and each of them is a fixed value.

Subsequently, the processor 41 causes the positioning meter 30 to start the positioning of the position of the carriage 50 (imaging position of the camera 10) (step S16). Further, the distance r measured in step S10 is registered as a distance r_old (step S18). Furthermore, the processor 41 controls the focusing position (focusing position) of the lens 11 such that the focusing position of the lens 11 of the camera 10 is the wall surface of the imaging target (step S20).

Subsequently, the processor 41 causes the camera 10 in which the focus position and the focal length are adjusted to start the imaging (step S22). The camera 10 that has received the instruction to start the imaging captures the static image at the interval of the constant time interval, captures the static image for each set traveling distance, or captures the moving image.

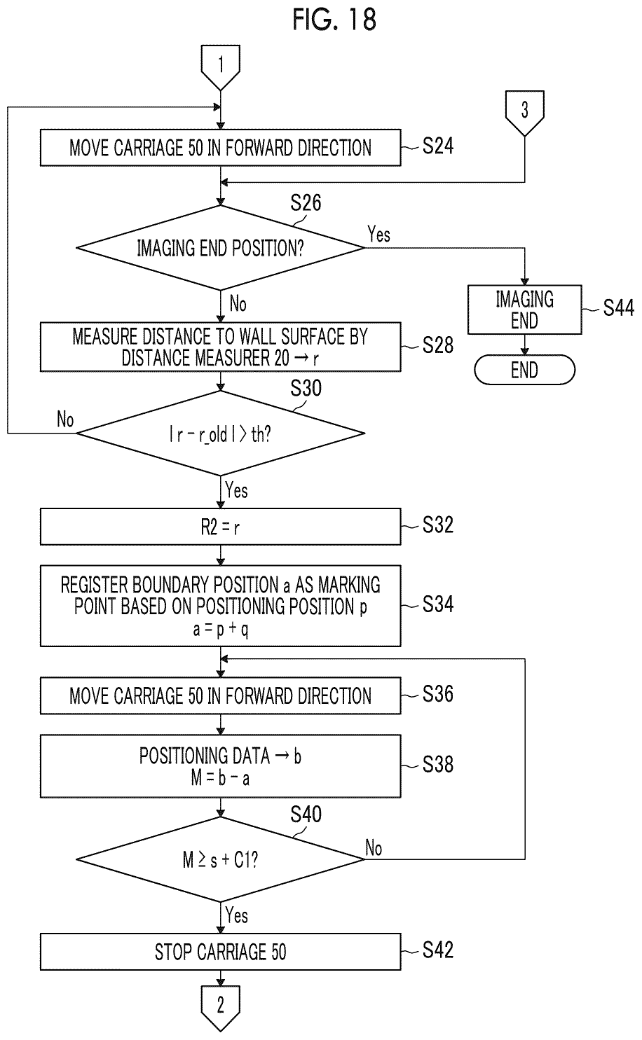

Further, in a case where the imaging by the camera 10 is started, the processor 41 causes the carriage 50 to move in the forward direction as shown in FIG. 18 (step S24). In a case where the carriage 50 is not the self-traveling type, the user manually pushes the carriage 50 to cause the carriage 50 to move in the forward direction.

The processor 41 determines whether or not the carriage 50 has reached an imaging end position based on the positioning data of the carriage 50 (step S26). In a case where the imaging end position is reached (in case of “Yes”), the imaging by the present imaging method is ended (step S44). On the other hand, in a case where the imaging end position is not reached (in case of “No”), the distance measurer 20 measures the distance to the wall surface, and the measured distance is set as the distance r (step S28).

The processor 41 determines whether or not an absolute value (|r−r_old|) of a difference between the distance r measured in step S28 and the distance r_old registered in step S18 exceeds the threshold value th (|r−r_old|>th) (step S30). In a case where the threshold value th is determined not to be exceeded (in case of “No”), the processing returns to step S24. That is, in a case where the threshold value th is not exceeded, determination is made that the spatial resolution of the wall surface in correspondence with the captured image captured by the current focus position and focal length of the camera 10 falls within the allowable range, and the movement of the carriage 50 in the forward direction and the imaging of the wall surface are continued.

That is, in a case where a shortest distance or a longest distance to the wall surface in the captured image, which is measured based on the distance measurement signal of the distance measurer 20, is set as the distance r and the absolute value (|r−r_old|) of the difference between the distance r and the distance r_old to the wall surface, for which the focus position and the focal length of the camera 10 are adjusted for the currently imaged wall surface, exceeds the threshold value th, the processor 41 can determine that the spatial resolution of the captured image does not fall within the allowable range.

On the other hand, in step S30, in a case where the threshold value th is determined to be exceeded (in case of “Yes”), the processor 41 registers the distance r measured in step S28 as the distance R2 (step S32).

Subsequently, the processor 41 obtains, by [Formula 4] described above, a change point (for example, the boundary position a between the wall surfaces T1 and T2 shown in FIG. 10) of the wall surface of which the distance has changed by exceeding the threshold value th, based on the positioning position p from the positioning meter 30, and registers the change point as a marking point (step S34).

The processor 41 causes the carriage 50 to move in the forward direction (step S36), and calculates, with the positioning data from the positioning meter 30 as b, a distance M obtained by subtracting a position of the registered marking point a from a position of the positioning data b (step S38).

The processor 41 determines whether or not the distance M (M=b−a) calculated in step S38 satisfies M≥s+C1 (step S40). As shown in FIG. 5, the wall surface T1 is no longer included in the captured image at the imaging position satisfying M≥ s+C1.

In step S40, in a case where M≥ s+C1 is determined not to be satisfied (in case of “No”), the processor 41 causes the processing to transition to step S36. In this case, a portion in correspondence with the wall surface T1 is imaged in the captured image, and the carriage 50 needs to be further moved in the forward direction.

On the other hand, in step S40, in a case where M≥s+C1 is determined to be satisfied (in case of “Yes”), the processor 41 causes the carriage 50 to stop (step S42).

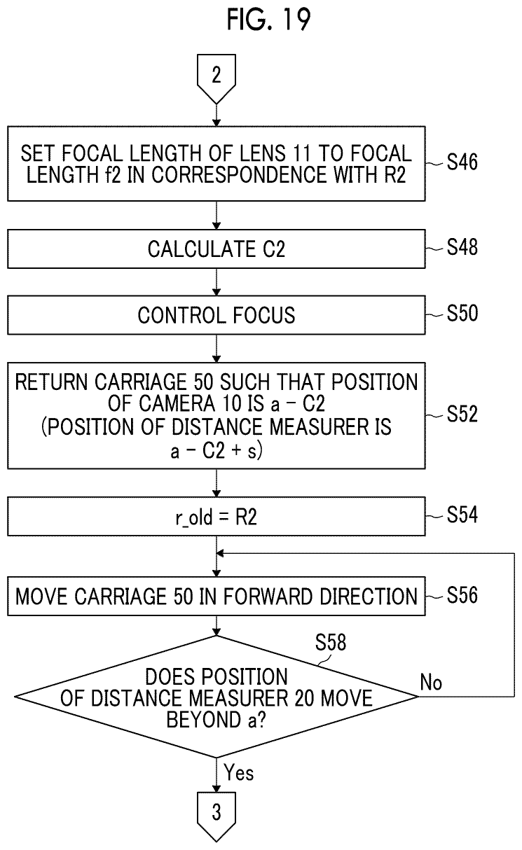

In a case where the carriage 50 is stopped, the processor 41 reads out, from the look-up table, the focal length f2 in correspondence with the distance R2 registered in step S32, and adjusts the focal length of the lens 11 of the camera 10 to the readout focal length f2 as shown in FIG. 19 (step S46).

Subsequently, the processor 41 calculates, by [Formula 3] described above, the width C2 based on the distance R2 and the focal length f2 (step S48). The width C2 is half of the width of the imaging range at the same distance as the wall surface T1, after the focal length of the lens 11 of the camera 10 is adjusted to the focal length f2 in correspondence with the distance R2 of the wall surface T2.

Further, the processor 41 controls the focus position of the lens 11 such that the focus position of the lens 11 of the camera 10 is at the wall surface T2 at the distance R2 (step S50).

In a case where the focus position and the focal length of the camera 10 are adjusted in correspondence with the distance R2 of the wall surface T2 during the stop of the carriage 50, the processor 41 causes the carriage 50 to move (return) in the backward direction such that the position of the camera 10 is the position (a-C2) (step S52). In a case where the position of the camera 10 is the position (a-C2), the camera 10 at the position (a-C2) images only the wall surface T1 as shown in FIG. 7. However, since the focus position of the camera 10 is adjusted for the wall surface T2, the wall surface T1 is out of focus.

Next, the processor 41 registers the distance R2 as the distance r_old (step S54) and causes the carriage 50 to move again in the forward direction (step S56).

Subsequently, the processor 41 determines whether or not the position of the distance measurer 20 has moved beyond the registered marking point a (step S58), and the processor 41 causes the processing to transition to step S56 in a case where the position thereof has not moved, and the processor 41 causes the processing to transition to step S26 shown in FIG. 18 in a case where the position thereof has moved.

In a case where the imaging end position is determined not to be reached in step S26, the processing from step S28 to step S58 is repeated again.

The imaging method shown in the flowcharts of FIGS. 17 to 19 is an embodiment of the imaging method according to the present invention, and the present invention is not limited to the imaging method shown in the flowcharts of FIGS. 17 to 19.

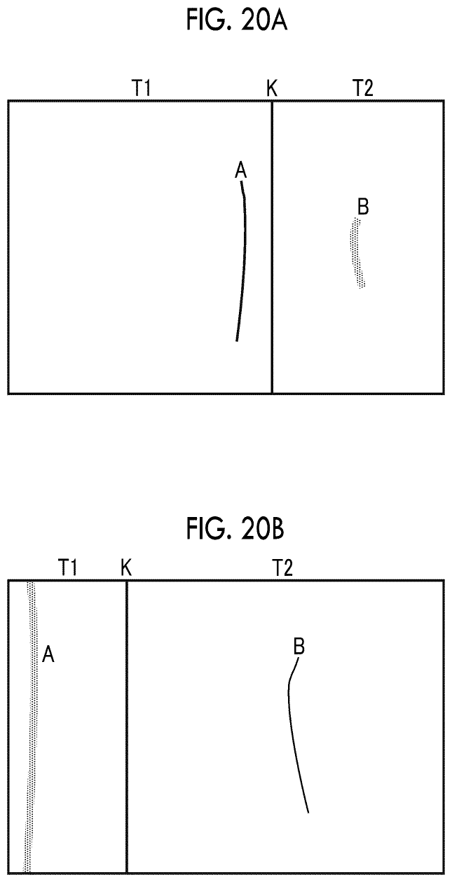

FIGS. 20A and 20B are diagrams showing an example of a captured image of a portion in which a diameter of the tunnel is largely changed.

In the captured images shown in FIGS. 20A and 20B, portions in correspondence with the wall surface T1 and the wall surface T2 respectively having different distances are imaged.

In FIGS. 20A and 20B, A indicates the fissuring of the wall surface T1, and B indicates the fissuring of the wall surface T2. Further, K indicates the boundary portion between the wall surface T1 and the wall surface T2.

The captured image shown in FIG. 20A is captured after the focusing position and the focal length of the camera 10 are adjusted in correspondence with the front wall surface T1, and thus the front wall surface T1 is in focus and a fissuring A of the wall surface T1 is clearly depicted. However, the rear wall surface T2 is out of focus, and thus the resolution of a fissuring B of the wall surface T2 is insufficient and unclear.

On the other hand, the captured image shown in FIG. 20B is captured after the focusing position and the focal length of the camera 10 are adjusted in correspondence with the rear wall surface T2, and thus the fissuring B of the rear wall surface T2 is clearly depicted. However, the front wall surface T1 is out of focus, and thus the resolution of the fissuring A of the wall surface T1 is insufficient and unclear.

For the portion in which the diameter of the tunnel is largely changed, it is difficult to maintain the resolution that depicts fine details with the front wall surface T1 and the rear wall surface T2 being in focus in single imaging.

Thus, in the imaging at the imaging position (imaging range) at which the front wall surface T1 and the rear wall surface T2 are imaged at the same time as shown in FIGS. 20A and 20B, the imaging (first imaging) in which the focus position and the focal length are adjusted for the front wall surface T1 as in the captured image shown in FIG. 20A and the imaging (second imaging) in which the focus position and the focal length are adjusted for the rear wall surface T2 as in the captured image shown in FIG. 20B are performed.

In a case where an image with maintained resolution is attempted to be captured according to a change in subject distance, there is a concern that an imaging time and the number of captured images are enormous and the work efficiency is extremely low in capturing, at all imaging points, a plurality of images with different focal lengths each time movement is made.

In the present invention, with the imaging using the distance information of the subject, in a case where there is no change in shape such as the tunnel diameter, the imaging and the movement are continued while maintaining the focus position and the focal length. In a case where there is a change exceeding the threshold value, with the control of the focus position and the focal length, it is possible to realize accurate imaging without waste. In this case, the captured image includes a subject having different imaging distance in a portion where the shape such as the tunnel diameter changes. Thus, the imaging condition is changed to perform the overlapping imaging, and the inspection can be performed without omission.

Further, with the use of the positioning information, it is possible to perform the imaging with high repeatability, and even in a case where the same place is desired to be imaged by changing the focal length or the focus position, it is possible to efficiently and accurately perform the imaging.

### [Others]

In the present embodiment, the case of imaging the tunnel of the railway has been described, but the subject is not limited to the tunnel of the railway, and the present invention can be employed for any subject as long as the subject is imaged while the camera is caused to move along the subject, such as a tunnel of a road or another subject.

In the present embodiment, for example, a hardware structure of a processing unit that executes various types of processing, such as a central processing unit (CPU), includes various processors to be described below. The various processors include a CPU that is a general-purpose processor functioning as various processing units by executing software (programs), a programmable logic device (PLD) that is a processor of which the circuit configuration can be changed after manufacture, such as a field programmable gate array (FPGA), a dedicated electrical circuit that is a processor having a circuit configuration designed exclusively to perform specific processing, such as an application specific integrated circuit (ASIC), and the like.

One processing unit may be configured of one of these various processors, or may be configured of two or more processors of the same type or different types (for example, a plurality of FPGAs or a combination of CPU and FPGA). The plurality of processing units may be configured of one processor. As an example of constituting the plurality of processing units by one processor, first, there is a form in which one processor is configured of a combination of one or more CPUs and software, as represented by a computer such as a client or a server, and the one processor functions as the plurality of processing units. Second, there is a form in which a processor that realizes the functions of the entire system including the plurality of processing units by one integrated circuit (IC) chip is used, as represented by a system on chip (SoC) or the like. In this manner, the various processing units are configured using one or more of the various processors as the hardware structure.

Further, more specifically, the hardware structure of the various processors is an electric circuit (circuitry) obtained by combining circuit elements such as semiconductor elements.

Furthermore, the present invention is not limited to the embodiments described above, and it is needless to say that various modifications can be made without departing from the spirit of the present invention.

### EXPLANATION OF REFERENCES

1-1: imaging apparatus
1-2: imaging apparatus
2: tunnel
10, 10A, 10B: camera
10a to 10e: second camera
11: lens
12: imaging element
14: camera attachment member
20: distance measurer
30: positioning meter
40: control device
41: processor
42: memory
43: operation unit
44: display
45: speaker
46: input/output interface
50, 50A, 50B: carriage
52: connection rod
S10 to S58: step

What is claimed is:

1. An imaging apparatus comprising:
a camera;
a distance measurer that measures a distance to a subject; and
a processor,
wherein the processor is configured to:
cause the camera to execute first imaging in which split imaging is spatially performed on the subject to acquire a captured image;
determine whether or not a target of interest is detectable from the captured image based on a distance measurement signal of the distance measurer; and
cause the camera to execute second imaging, which has an imaging condition different from that of the first imaging, for an imaging range of the subject for which the determination is determined to be negative.

2. The imaging apparatus according to claim 1,
wherein the determination is whether or not a resolution of the captured image falls within an allowable range.

3. The imaging apparatus according to claim 2,
wherein the resolution of the captured image is a spatial resolution of the captured image.

4. The imaging apparatus according to claim 3,
wherein the subject and the camera are relatively moved in a first direction, and the subject is continuously imaged.

5. The imaging apparatus according to claim 4,
wherein the spatial resolution of the captured image is a spatial resolution of an entire region of the captured image.

6. The imaging apparatus according to claim 2,
wherein the imaging range is an imaging range of the subject that is determined not to fall within the allowable range.

7. The imaging apparatus according to claim 4,
wherein the first imaging is imaging in which a spatial resolution of a first region in the captured image falls within an allowable range and a spatial resolution of a second region in the captured image does not fall within the allowable range, and
the second imaging is imaging in which the spatial resolution of the first region does not fall within the allowable range and the spatial resolution of the second region falls within the allowable range.

8. The imaging apparatus according to claim 3,
wherein the processor is configured to:
estimate the spatial resolution of the captured image based on an imaging setting value of the camera and the distance measurement signal of the distance measurer; and
determine whether or not the estimated spatial resolution of the captured image falls within the allowable range.

9. The imaging apparatus according to claim 3,
wherein the processor is configured to:
acquire a shortest distance or a longest distance to the subject in the captured image based on the distance measurement signal of the distance measurer; and
in a case where a distance to the subject in the first imaging is r_old, the shortest distance or the longest distance is r, and a threshold value which is a determination criterion for the allowable range of the spatial resolution is th, determine that the spatial resolution of the captured image does not fall within the allowable range in a case where |r−r_old|>th.

10. The imaging apparatus according to claim 7,
wherein the first imaging is imaging in which a focusing position and a focal length of the camera are adjusted for the first region, and
the second imaging is imaging in which the focusing position and the focal length of the camera are adjusted for the second region.

11. The imaging apparatus according to claim 7,
wherein the processor is configured to:
cause the camera to execute the first imaging for the imaging range during the movement of the camera in the first direction; and
cause the camera to execute the second imaging during the movement of the camera in the first direction after the first imaging is ended and then the camera returns to at least a position at which re-imaging of the imaging range is possible.

12. The imaging apparatus according to claim 11,
wherein the processor is configured to:
automatically adjust a focusing position and a focal length of the camera based on a distance to the subject in correspondence with the second region, or output, to an indicator, an instruction to prompt a user to adjust at least one of the focusing position or the focal length of the camera, before the camera returns to the position at which the re-imaging is possible; and
execute the second imaging after the automatic adjustment or after the user adjusts at least one of the focusing position or the focal length of the camera.

13. The imaging apparatus according to claim 4, further comprising:
a positioning meter that measures a position of the camera,
wherein the processor is configured to:
cause the camera to move in a second direction opposite to the first direction in a case where the first imaging for the imaging range is ended; and
cause the camera to move again in the first direction in a case where detection is made that the camera returns to at least a position at which re-imaging of the imaging range is possible during the movement of the camera in the second direction based on a positioning signal of the positioning meter, and cause the camera to execute the second imaging for the imaging range.

14. The imaging apparatus according to claim 4, further comprising:
a positioning meter that measures a position of the camera in a movement direction; and
an indicator that instructs a user to perform a movement operation of the camera by the user,
wherein the processor is configured to:
output, to the indicator, an instruction to cause the camera to move in a second direction opposite to the first direction in a case where the first imaging for the imaging range is ended during the movement of the camera in the first direction; and
output, to the indicator, an instruction to cause the camera to move again in the first direction in a case where detection is made that the camera returns to at least a position at which re-imaging of the imaging range is possible during the movement of the camera in the second direction based on a positioning signal of the positioning meter.

15. The imaging apparatus according to claim 1,
wherein the distance measurer is a laser distance measurer, and the laser distance measurer scans the subject with laser light to measure the distance in correspondence with the entire region of the captured image.

16. The imaging apparatus according to claim 7,
wherein the processor is configured to:
adjust a focusing position of the camera based on the distance measurement signal measured by the distance measurer;
adjust the focusing position of the camera based on the distance measurement signal measured for the first region of the captured image in a case where the first imaging is executed; and
adjust the focusing position of the camera based on the distance measurement signal measured for the second region of the captured image in a case where the second imaging is executed.

17. The imaging apparatus according to claim 1,
wherein the camera is configured of a plurality of second cameras, and the plurality of second cameras are disposed in an arc shape,
a plurality of captured images captured by the plurality of second cameras include regions overlapping with each other, and
the processor is configured to:
determine whether or not the target of interest is detectable from the captured image based on the distance measurement signal of the distance measurer for each captured image captured by each of the plurality of second cameras; and
cause, to execute the first imaging and the second imaging, one or more cameras among the plurality of second cameras that have captured the captured image for which the determination is determined to be negative.

18. The imaging apparatus according to claim 1,
wherein the camera is configured of a first camera and a second camera, and the second camera is disposed at a position different from the first camera in a movement direction, which is behind the first camera by a distance equal to or larger than a length of the imaging range in the movement direction of the camera, and
the processor is configured to:
cause the first camera to execute the first imaging; and
cause the second camera to execute the second imaging for the imaging range.

19. The imaging apparatus according to claim 7,
wherein the processor is configured to:
perform panorama composition on the captured images, and the captured images used for the panorama composition of the imaging range are an image of the first region in the captured image by the first imaging and an image of the second region in the captured image by the second imaging.

20. An imaging method of an imaging apparatus including a camera, a distance measurer that measures a distance to a subject, and a processor, the imaging method executed by the processor comprising:
a step of causing the camera to execute first imaging in which split imaging is spatially performed on the subject to acquire a captured image;
a step of determining whether or not a target of interest is detectable from the captured image based on a distance measurement signal of the distance measurer; and
a step of causing the camera to execute second imaging, which has an imaging condition different from that of the first imaging, for an imaging range of the subject for which the determination is determined to be negative.
